(19) United States
(12) Patent Application Publication
(10) Pub. No.: US 2025/0196587 A1
(43) Pub. Date: Jun. 19, 2025

(54) COMPONENT ARRANGEMENT FOR COMPONENTS OF A REFRIGERANT CIRCUIT OF A VEHICLE AIR CONDITIONING SYSTEM AND AIR CONDITIONING SYSTEM WITH REFRIGERANT CIRCUIT FOR A VEHICLE

(71) Applicant: Hanon Systems, Daejeon (KR)

(72) Inventors: Toni Spies, Kerpen (DE); Florian Bieregger, München (DE); Balthasar Schillmeit, Bonn (DE); Gerald Richter, Aachen (DE); Bernd Guntermann, Lennestadt (DE)

(21) Appl. No.: 18/847,867

(22) PCT Filed: Jul. 20, 2023
(86) PCT No.: PCT/KR2023/010456

§ 371 Date: Sep. 17, 2024

(30) Foreign Application Priority Data
Aug. 11, 2022 (DE) 10 2022 120 308.5
Jul. 14, 2023 (DE) 10 2023 118 683.3

(51) Int. Cl. B60H 1/32; B60H 1/00

(52) U.S. Cl. CPC B60H 1/3229; B60H 1/00392; B60H 1/3226; B60H 2001/3292

(57) ABSTRACT

A component arrangement for components of a refrigerant circuit of an air conditioning system for a vehicle, wherein the component arrangement has a heat exchanger for evaporating a refrigerant, an electrically operated compressor, which is arranged in a compressor housing configured for compressing a vaporous refrigerant, a valve block with valves for controlling flow paths of the refrigerant, and refrigerant lines, by means of which the components are fluidically connected to one another. The invention is characterized in that the components of the component arrangement are each coupled directly to the compressor housing without separate decoupling, wherein the compressor housing has a mounting point at which the component arrangement is attachable to the vehicle, and wherein the refrigerant lines have connectors for fluidic integration into the refrigerant circuit of the air conditioning system.

### CROSS REFERENCE TO RELATED PATENT APPLICATIONS

This is a U.S. national phase patent application of PCT/KR2023/010456 filed Jul. 20, 2023 which claims the benefit of and priority to German Patent Application No. DE 10 2023 118 683.3 filed on Jul. 14, 2023 and German Patent Application No. DE 10 2022 120 308.5 filed on Aug. 11, 2022, the entire contents of each of which are incorporated herein by reference for all purposes.

### TECHNICAL FIELD

The invention relates to a component arrangement for components of a refrigerant circuit of an air conditioning system for a vehicle, especially for a battery electric vehicle (BEV). Further, the invention relates to an air conditioning system with a refrigerant circuit for a vehicle, especially for a battery electric vehicle (BEV).

### BACKGROUND ART

Heat pump-based air conditioning systems are more and more commonly employed in vehicles, in particular battery electric vehicles, for temperature control or air conditioning of the vehicle. According to the prior art, components or sub-components of a refrigerant circuit of the air conditioning system, such as heat exchangers, refrigerant compressors and valve blocks with valves as well as associated connecting lines, are often fastened at predetermined positions with separate supports in the vehicle or on a vehicle body with separate decoupling. Alternative configurations use central and larger-sized support devices to which multiple components of the refrigerant circuit are attached decoupled from one another, wherein the support devices are attached in the vehicle, for example, to the vehicle body. While a central support causes increased weight due to a required robust design for receiving the components, multiple individual supports for the separate attachment of components lead to an increased assembly effort and increased costs for the required packaging material due to numerous individual parts.

It was found that the use of a central support requires a comparatively large structural installation space, which limits the design possibilities of the air conditioning system with regard to accommodation in the vehicle. In particular, because of the high space requirement and the specific position specifications for components, central and thus bulky supports reduce structural flexibility when designing the air conditioning system. Thus, the structural installation space taken up by a central support with components of the refrigerant circuit of the air conditioning system separately decoupled thereon causes space issues within the vehicle design concept for peripheral components. A particular disadvantage is also that this increases the weight of the entire air conditioning system. Furthermore, it is problematic that, if the clearances between the separately decoupled components of the refrigerant circuit of the air conditioning system are too large, thermal bridges can be formed, which can have a disadvantageous effect on the system efficiency of the air conditioning system.

### SUMMARY

The object of the invention is to propose a compact arrangement of components of a refrigerant circuit of an air conditioning system of a vehicle which does not require an additional, large support for separate coupling of the components. Further, an object is to propose a corresponding air conditioning system for a vehicle.

The object is achieved by a component arrangement having the features as shown in the drawings and described herein.

According to the concept of the invention, an arrangement of components of a refrigerant circuit of an air conditioning system of a vehicle, especially of a battery electric vehicle (BEV), is provided in a component arrangement for these components provided for this purpose. The component arrangement has, as components of a refrigerant circuit of an air conditioning system for a vehicle, especially for a battery electric vehicle (BEV), at least one heat exchanger, an electrically operated compressor, a valve block with valves as well as refrigerant lines, by means of which the components are fluidically connected to one another. The heat exchanger serves to evaporate a refrigerant, wherein the electrically operated compressor arranged in a compressor housing is configured for compressing the vaporous refrigerant. To control flow paths of the refrigerant, the valve block with the valves is provided, wherein the valves can be configured as 3/2-way valves or 2/2-way valves. According to the invention, the components of the component arrangement are each connected to one another with separate decoupling directly and immediately coupled to the compressor housing, wherein the compressor housing has a first mounting point at which the component arrangement is attachable to the vehicle. As such, the refrigerant lines have connectors for fluidic integration of the component arrangement into the refrigerant circuit of the air conditioning system.

For the purposes of the invention, a mounting point is to be understood as a position on the compressor housing or on the component arrangement to which the compressor housing or the component arrangement as a whole is attachable to the vehicle, especially to a body of the vehicle. Alternatively, the mounting point can be configured as an integrated structure with which the compressor housing or the component arrangement is attachable to the vehicle, especially to a body of the vehicle. Further, it may be provided for the component arrangement to be directly, that is without an additional support structure, attachable to a body of the vehicle at the first mounting point.

The component arrangement forms a self-supporting structure for selected components of the refrigerant circuit of the air conditioning system, wherein the compressor housing forms a central support for the selected components. The mechanical coupling and a compact arrangement of the components on the compressor housing impart particularly good rigidity, in particular good torsional rigidity, to the component arrangement so that no additional robust supports are required. Therefore, a support, which is attachable at the at least one mounting point for attachment of the component arrangement to the vehicle, can be configured to be deliberately designed to be simple and dimensioned with low structural complexity. A mechanical coupling, that is a mechanical connection between the components, additionally promotes the rigidity of the component arrangement and thus contributes to an even better rigidity of the component arrangement. For this reason, the components of the component arrangement are fixedly connected to one another by means of a mechanical coupling.

Preferably, the compressor housing, which forms the central support for the components of the component arrangement, is configured to be particularly torsionally rigid and robust. A torsionally rigid structure is achieved by additional structural elements, such as cross braces, for example. The compressor housing can have such additional structural elements and/or be configured from a material which imparts increased rigidity, in particular torsional rigidity, to the compressor housing. As an example, as structural elements imparting rigidity, additional cross braces or cross ribs can be configured on the compressor housing.

As an essential part of the component arrangement, the compressor housing is dimensioned such that it can receive and carry the components connected to the compressor housing, that is at least the heat exchanger and the valve block. The compressor housing with the components attached thereto, which are also referred to as sub-components, replaces a large support which, according to the prior art, is required at a modular level for receiving components, component parts or sub-components. At the modular level, all components are fixedly connected to the compressor housing in which the compressor is arranged as a component of the refrigerant circuit.

Further, the component arrangement can have a second mounting point for attachment of the component arrangement to the vehicle.

According to an advantageous embodiment of the component arrangement according to the invention, in addition to the mounting point configured on the compressor housing, a second mounting point for attachment to the vehicle may be configured on the compressor housing or on a component coupled to the compressor housing. As such, it is particularly advantageous if the mounting point configured on the compressor housing and the further, second mounting point are arranged diametrically with respect to the component arrangement, which contributes to a favorable load distribution.

Preferably, the component arrangement has exactly two mounting points for attachment to a support structure for attachment to the vehicle, in particular for attachment to a body of the vehicle, wherein the two mounting points are arranged diametrically with respect to the component arrangement. This means that the mounting points to which a support structure is attachable can be located to be diametrically arranged in different positions of the component arrangement. Alternatively, it can be provided that the two mounting points each have integrated structures for attachment to the vehicle, wherein these structures are configured diametrically, that is at opposite positions on the component arrangement.

According to a further embodiment of the component arrangement, support structures for attachment to a vehicle, in particular to a vehicle body, can also be provided as part of the component arrangement. Accordingly, an upper support structure can be attached at the mounting point configured on the compressor housing, wherein a lower support structure is attached at the further mounting point. Decoupling elements can be arranged between the support structures and the component arrangement, that is between the upper support structure and the component arrangement as well as between the lower support structure and the component arrangement. The support structures can be attached to the component arrangement with one or two attachment means, for example screws. Preferably, the support structures are designed to be structurally simple and compact and have a low weight. They additionally serve as an interface or connecting element for attachment and integration of the component arrangement into various vehicle space concepts.

The design of the compressor housing provides for a particularly compact and robust coupling of the components to be enabled in order to avoid movements between the components, in particular at mutually contacting interfaces of the components. Thus, the compressor housing can have an integrated structure which holds the components in a fixed and aligned position. This is also advantageous to minimize leaks and vibrations.

An intermediate element in the form of a surface seal made of an elastic material such as plastic or rubber can be arranged between oppositely interconnected components and/or between the compressor housing and oppositely coupled components. Advantageously, such intermediate elements contribute to sealing and to reducing vibrations.

The compact design of the component arrangement as such provides that the refrigerant lines within the component arrangement are as short as possible, i.e., have short lengths. For this reason, the refrigerant lines fluidically connecting the components can be configured to be fully integrated. This means that the refrigerant lines can be configured as part of the housings of the components, wherein openings of the integrated refrigerant lines are configured at the housing boundaries. The integrated refrigerant lines can correspond with one another with their openings on adjoining component housings such that the refrigerant passes from a first component into a second component without separate refrigerant lines being required between the components. This relates in particular to the refrigerant lines between the components of the component arrangement, so that no additional hose lines are required for the flow paths within the component arrangement. In order to avoid leaks, seals in the form of O-rings or in the form of surface seals can be configured between adjoining components, in particular in the area of refrigerant lines. Furthermore, it can be provided that the refrigerant lines fluidically connecting the components to one another are configured in the compressor housing. Thus, the compressor housing can have internal refrigerant lines to enable the flow of the refrigerant between the components. In this way, an integrated flow path for refrigerant is provided if the components of the component arrangement are coupled to one another. Advantageously, this results in a reduction in the number of separate refrigerant lines, and the overall line length of the refrigerant lines is reduced.

A particularly compact arrangement of the component arrangement can be achieved by the heat exchanger and the valve block being coupled to the compressor housings as components being mechanically connected to one another offset by an angle of 90° with respect to a rotational axis of the compressor.

The compressor housing can have a plurality of attachment elements or surface to enable a simple and rapid assembly of the components. Similarly, the components may have attachment elements or surfaces to enable a space-saving arrangement and attachment to the compressor housing and to one another. According to a particularly preferred embodiment of the component arrangement according to the invention, it can be provided that each component of the component arrangement is coupled and connected to the compressor housing and to at least one further component of the component arrangement. A corresponding embodiment promotes a compact space-saving arrangement of the components of the component arrangement.

Preferably, the components are fixedly screwed to one another. In addition to screw connections, U-clamp connections, for example, can also be provided as the attachment elements.

The housings of the components can further also have interlocking elements with latching and/or plug-in connections which make it possible for the connections between the components to do without additional separate connecting elements.

In order to make the assembly of the component arrangement as simple as possible, it can be provided that all connectors of the refrigerant lines for fluidic integration into the refrigerant circuit of the air conditioning system are configured to be concentrated on one side of the component arrangement. This means that all the connectors of the refrigerant lines are located on one side of the component arrangement. As a result, a specific connecting link is predetermined for fluidic integration into the refrigerant circuit of the air conditioning system, so that no additional connecting lines are required which extend the refrigerant flow paths.

The component arrangement according to the invention is in particular usable in a refrigerant circuit of an air conditioning system of a vehicle, especially of a battery electric vehicle (BEV). The component arrangement according to the invention is particularly suitable for BEV because of its compact design.

A use of the component arrangement is provided for operation with the refrigerant R1234yf, R134a, R744, R404a, R600a, R290, R152a or R32 or a mixture of two or more of these refrigerants.

A further aspect of the invention is an air conditioning system with a refrigerant circuit in a vehicle, especially in a battery electric vehicle (BEV). The air conditioning system has at least the following components:
a heat exchanger for evaporating a refrigerant,
an electrically operated compressor, which is arranged in a compressor housing configured for compressing a vaporous refrigerant,
a valve block with valves for controlling flow paths of the refrigerant, and
refrigerant lines, by means of which the components are fluidically connected to one another.

The air conditioning system is characterized in that the components within a component arrangement are each connected without separate decoupling being directly coupled to the compressor housing, wherein the compressor housing has a mounting point at which the component arrangement is attached to the vehicle, in particular to a body of the vehicle, wherein the refrigerant lines are fluidically connected to the refrigerant circuit of the air conditioning system by means of connectors. By connecting the component arrangement to the refrigerant lines of the air conditioning system, a closed refrigerant circuit is configured.

For operation of the component arrangement according to the invention with the refrigerant R290, amongst others, it is not necessary that, in addition to the components associated with the component arrangement, further refrigeration circuit components have to be provided.

The component arrangement of the air conditioning system can be configured in accordance with one or more of the embodiments described above.

The advantages achievable with the invention are summarized as follows:
Elimination of the central support for separate connection of components, thereby
   cost reduction,
   more compact design,
   improved acoustic performance due to increased mass over a separate compressor,
   weight reduction, and
   overall improved ecological footprint during production, shipping and operation in the vehicle.

### DESCRIPTION OF DRAWINGS

Further details, features, and advantages of embodiments of the invention will become apparent from the following description of exemplary embodiments with reference to the accompanying drawings. In the drawings:

FIG. 1: shows a schematic perspective representation of an exemplary embodiment of the component arrangement according to the invention,

FIG. 2: shows a further schematic perspective representation of the exemplary embodiment of the component arrangement according to the invention shown in FIG. 1,

FIG. 3: shows a first side view of the exemplary embodiment of the component arrangement according to the invention shown in FIG. 1,

FIG. 4: shows a second side view of the exemplary embodiment of the component arrangement according to the invention shown in FIG. 1,

FIG. 5: shows a third side view of the exemplary embodiment of the component arrangement according to the invention shown in FIG. 1,

FIG. 6: shows a fourth side view of the exemplary embodiment of the component arrangement according to the invention shown in FIG. 1,

FIG. 7: shows a top view of the exemplary embodiment of the component arrangement according to the invention shown in FIG. 1, and

FIG. 8: shows a bottom view of the exemplary embodiment of the component arrangement according to the invention shown in FIG. 1.

In the figures, recurring features are provided with the same reference numerals.

### DESCRIPTION OF AN EMBODIMENT

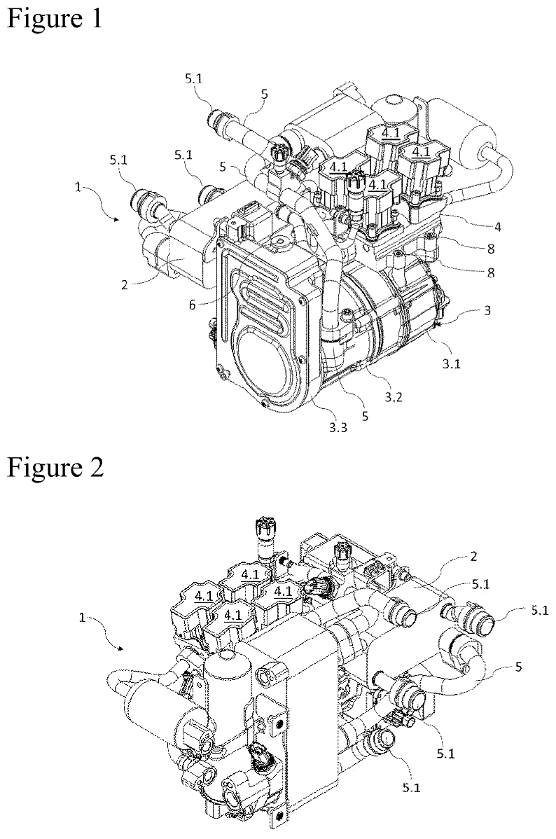

FIG. 1 shows a schematic perspective representation of an exemplary embodiment of the component arrangement 1 according to the invention. The component arrangement 1 is provided for integration into a refrigerant circuit of an air conditioning system of a vehicle and comprises, as components of the refrigerant circuit of the air conditioning system for a vehicle, especially for a battery electric vehicle (BEV), at least one heat exchanger 2, an electrically operated compressor which is arranged in a compressor housing 3, a valve block 4 with four valves 4.1 as well as refrigerant lines 5 by means of which the components are fluidically connected to one another. In this embodiment, the valve block 4 has four valves 4.1. However, it is also possible to provide an embodiment with a valve block as a component in which fewer or more than four valves for controlling flow paths of a refrigerant are received. The refrigerant lines 5 have connectors 5.1 by means of which the component arrangement 1 can be fluidically integrated into the refrigerant circuit of the air conditioning system of the vehicle.

The heat exchanger 2 serves to evaporate a refrigerant supplied via refrigerant lines 5, wherein the electrically operated compressor arranged in the compressor housing 3 is configured for compressing the vaporous refrigerant. To control flow paths of the refrigerant, the valves 4.1 of the valve block 4 can be configured as 3/2-way valves or 2/2-way valves. According to the invention, the heat exchanger 2 and the valve block 4 as the components are each coupled directly to the compressor housing 3 and connected to one another without separate decoupling. As such, the heat exchanger 2 and the valve block 4 are connected to one another and to the compressor housing 3, being arranged offset with respect to an axis of rotation of the compressor by an angle of 90°. This arrangement enables a particularly compact arrangement of the heat exchanger 2 and the valve block 4 within the component arrangement 1.

For attachment of the components 2 and 4 to the compressor housing 3, threaded holes are configured in the compressor housing 3, wherein the components 2 and 4 have corresponding screw bushings through which screws 8 inserted into the compressor housing 3 are screwable to screw the components 2 and 4, that is the heat exchanger 2 and the valve block 4, to the compressor housing 3. The compressor housing 3 has receiving structures in the form of profiles, stop edges and cavities in which the heat exchanger 2 and the valve block 4 received are held in position.

The refrigerant lines 5 are configured to be fully integrated between the components of the component arrangement 1, which is why they are concealed. Only some of the refrigerant lines 5 are configured as separate connecting lines for fluidic connection of the components and protrude from the components for maintenance purposes. Inspection valves can be arranged along externally accessible refrigerant lines 5 to be able to shut off portions of the refrigerant lines 5.

The compressor housing 3 is configured with three successive housing segments 3.1, 3.2 and 3.3, wherein the first housing segment 3.1 receives the compressor, the electric motor for driving the compressor is arranged in the second housing segment 3.2, and an inverter is received in the third housing segment 3.3.

The valve block 4 is screwed to the first housing segment 3.1 by means of screws 8. As such, the valve block 4 is arranged in a radial orientation with respect to an axis of rotation of the compressor or of the electric motor.

A first mounting point 6 in the form of a threaded hole is configured on an upper side of the third housing segment 3.3 of the compressor housing 3. In the position of the first mounting point 6, the component arrangement 1 is attachable to a support structure for attachment in a vehicle or directly to a vehicle body. The attachment to the first mounting point 6 can have a decoupling in the form of a rubber buffer.

FIG. 2 shows a further schematic perspective representation of the exemplary embodiment of the component arrangement 1 according to the invention shown in FIG. 1. The representation permits a view of the heat exchanger 2 and four connectors 5.1 of refrigerant lines 5 of the component arrangement 1. The four connectors 5.1 of refrigerant lines 5 are configured on one side of the component arrangement 1.

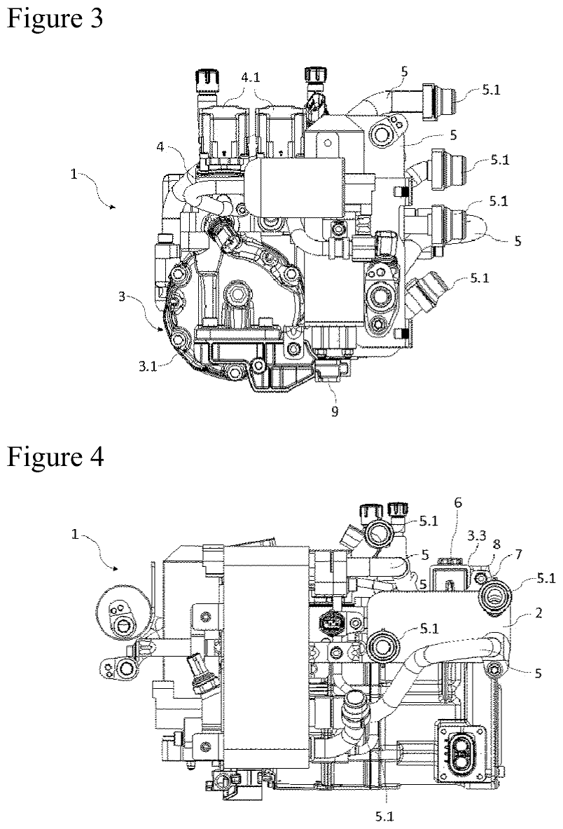

FIG. 3 shows a first side view of the exemplary embodiment of the component arrangement 1 according to the invention shown in FIG. 1. The representation permits a view of an end face of the first housing segment 3.1, by which the compressor is housed. Above the compressor housing 3, the valve block 4 with the valves 4.1 is arranged to be screwed to the compressor housing 3. The heat exchanger 2 is arranged to the right of the valve block, wherein the heat exchanger 2 is screwed to the valve block 4 and to the compressor housing 3.

The reference numeral 9 denotes the position of a second mounting point for attachment of the component arrangement 1 to a support structure for attachment in a vehicle. The second mounting point is configured on a lower side of the component arrangement 1.

FIG. 4 shows a second side view of the exemplary embodiment of the component arrangement 1 according to the invention shown in FIG. 1. The representation permits a top view of the side of the component arrangement 1 on which the four connectors 5.1 of the refrigerant lines 5 are configured. At a plate element 7, the heat exchanger 2 is screwed to the third housing segment 3.3 of the compressor housing 3 with a screw 8.

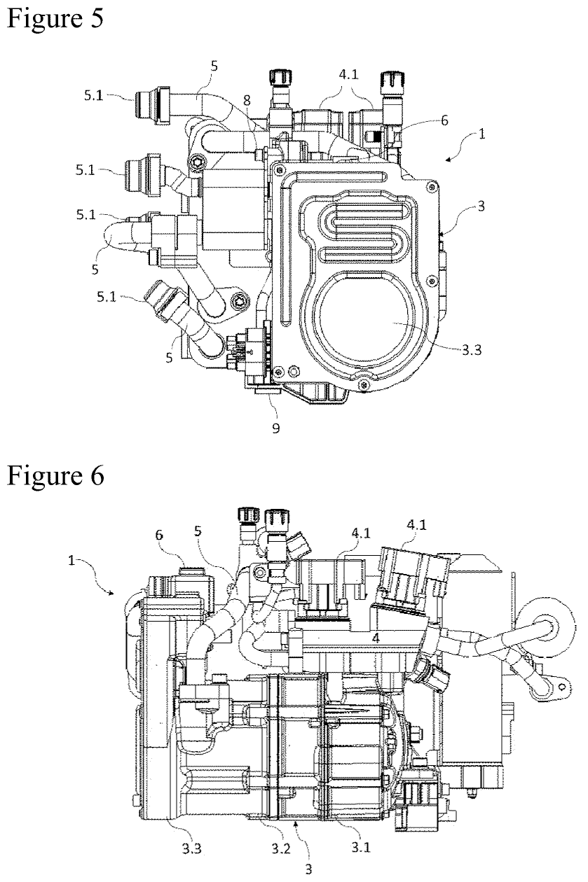

FIG. 5 shows a third side view of the exemplary embodiment of the component arrangement 1 according to the invention shown in FIG. 1. The representation permits a view of an end face of the third housing segment 3.3, by which the inverter is housed. The first mounting point 6 is located on the upper side of the third housing segment 3.3.

FIG. 6 shows a fourth side view of the exemplary embodiment of the component arrangement 1 according to the invention shown in FIG. 1. The representation permits a view of the longitudinal side of the compressor housing 3. The position of the first mounting point 6 and the position of the second mounting point 9 on the component arrangement 1 are located substantially diametrically opposite.

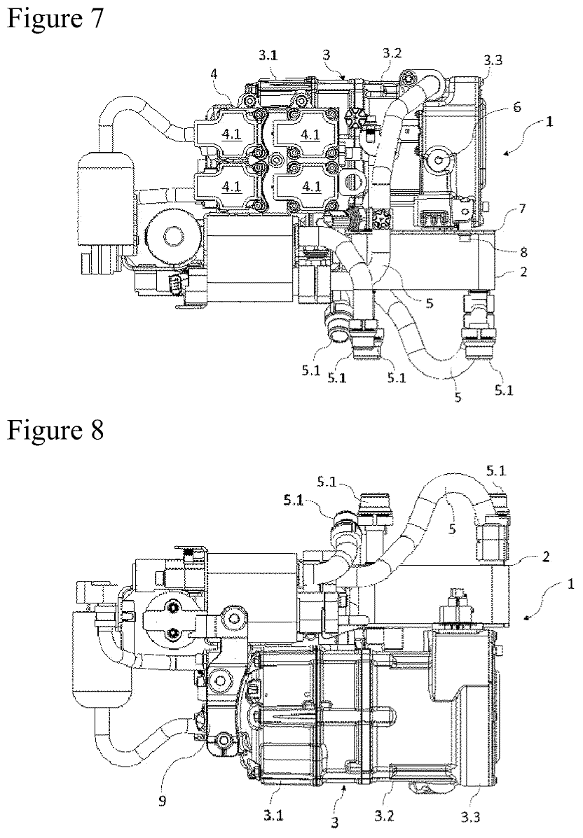

FIG. 7 shows a top view of the exemplary embodiment of the component arrangement 1 according to the invention shown in FIG. 1. The representation permits a view of an upper side of the component arrangement 1. At a plate element 7, the heat exchanger 2 is screwed to the third housing segment 3.3 of the compressor housing 3 with a screw 8.

FIG. 8 shows a bottom view of the exemplary embodiment of the component arrangement 1 according to the invention shown in FIG. 1. The representation permits a view of the second mounting point 9 configured on the lower side of the component arrangement 1, which is configured as a plate with openings. An attachment to the second mounting point 9 can have a decoupling in the form of a rubber buffer.

1-16. (canceled)

17. A component arrangement for components of a refrigerant circuit of an air conditioning system for a vehicle comprising:
a heat exchanger for evaporating a refrigerant,
an electrically operated compressor, which is arranged in a compressor housing configured for compressing a vapor of the refrigerant,
a valve block with valves for controlling flow paths of the refrigerant, and
refrigerant lines, by means of which the components are fluidically connected to one another, wherein the components of the component arrangement are each coupled directly to the compressor housing without separate decoupling, wherein the compressor housing has a first mounting point at which the component arrangement is attachable to the vehicle, and wherein the refrigerant lines have connectors for fluidic integration into the refrigerant circuit of the air conditioning system.

18. The component arrangement according to claim 17, wherein the compressor housing is configured to be torsionally rigid.

19. The component arrangement according to claim 17, further comprising a second mounting point for attachment of the component arrangement to the vehicle.

20. The component arrangement according to claim 19, wherein the first mounting point configured on the compressor housing and the second mounting point are arranged diametrically opposite.

21. The component arrangement according to claim 17, wherein the compressor housing has an integrated structure which holds the components in a fixed and aligned position.

22. The component arrangement according to claim 17, wherein an intermediate element in a form of a surface seal made of an elastic material is arranged each between oppositely interconnected ones of the components and/or between the compressor housing and oppositely coupled ones of the components.

23. The component arrangement according to claim 17, wherein the refrigerant lines fluidically connecting the components are configured to be fully integrated.

24. The component arrangement according to claim 17, wherein the compressor housing has internal ones of the refrigerant lines to enable a flow of the refrigerant between the components.

25. The component arrangement according to claim 17, wherein the heat exchanger and the valve block are coupled to the compressor housing, being connected to one another offset by an angle of 90° with respect to a rotational axis of the compressor.

26. The component arrangement according to claim 17, wherein the compressor housing has a plurality of attachment elements or surfaces to enable a simple and rapid assembly of the components.

27. The component arrangement according to claim 17, wherein the components have attachment elements or surfaces to enable a space-saving arrangement and attachment to the compressor housing and to one another.

28. The component arrangement according to claim 17, wherein each of the components of the component arrangement is coupled and connected to the compressor housing and further to at least one of the components of the component arrangement.

29. The component arrangement according to claim 17, wherein the connectors of the refrigerant lines are configured for fluidic integration into the refrigerant circuit of the air conditioning system on one side of the component arrangement.

30. A use of the component arrangement according to claim 17, in a battery electric vehicle (BEV).

31. A use of the component arrangement according to claim 17, for operation with a refrigerant R1234yf, R134a, R744, R404a, R600a, R290, R152a or R32 or a mixture of two or more of the refrigerants.

32. An air conditioning system with a refrigerant circuit in a vehicle comprising at least the following components:
a heat exchanger for evaporating a refrigerant,
an electrically operated compressor, which is arranged in a compressor housing configured for compressing a vapor of the refrigerant,
a valve block with valves for controlling flow paths of the refrigerant, and
refrigerant lines, by means of which the components are fluidically connected to one another, wherein the components within a component arrangement are each connected, being directly coupled to the compressor housing without separate decoupling, wherein the compressor housing has a mounting point at which the component arrangement is attached to the vehicle, and wherein the refrigerant lines are fluidically connected to the refrigerant circuit of the air conditioning system by means of connectors.
